(19) United States
(12) Patent Application Publication
(10) Pub. No.: US 2007/0016884 A1
(43) Pub. Date: Jan. 18, 2007

(54) Apparatus, method, and medium for designing semiconductor integrated circuit

(75) Inventor: Yutaka Nishimaru, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/481,854

(22) Filed: Jul. 7, 2006

(30) Foreign Application Priority Data
Jul. 12, 2005 (JP) 2005-202966

(51) Int. Cl. G06F 17/50

(52) U.S. Cl. 716/13; 716/14; 716/6

(57) ABSTRACT

A clock tree configuration is modified so that a branch point of a clock tree is arranged closer to a leaf of the tree, thereby restraining an increase in a clock skew due to variation.

### FIELD OF THE INVENTION

The present invention relates to an apparatus, a method, and a medium recording a computer program for designing a semiconductor integrated circuit.

### BACKGROUND OF THE INVENTION

Today's semiconductor technology has achieved remarkable progress in high integration density and high-speed operation of a semiconductor integrated circuit (LSI). A clock tree synthesis (CTS) tool is used in layout design of the semiconductor integrated circuit for reducing clock variations at clock supply destinations. In the clock tree synthesis, branching to a plurality of clock paths from a clock supply source is carried out based on circuit connection information and placement information and buffers (referred to as a “CTS buffer”) are inserted so as to make clock delays from the clock supply source to respective branched leafs of the tree equal, thereby reducing clock skew.

FIG. 7 shows an example of a circuit configuration designed by a conventional clock tree synthesis tool. A clock propagation path from a root buffer 10 that constitutes a clock supply source (also referred to as a “clock source”) is branched to two paths through a buffer 11. The clocks on the paths branched at the branch point 20 are supplied to a group A constituted from flip-flops 21 and 22 and a group B constituted from flip-flops 23 to 25 through buffer 12 and 13, respectively. Reference numerals 1, 2, 3, and 4 in FIG. 7 denote nets.

In automated layout design of a semiconductor integrated circuit (LSI), a plurality of flip-flops in the semiconductor integrated circuit are grouped according to placement positions thereof. Generally, flip-flops which are placed close to one another are grouped in the same group, and are driven in common by the same clock signal (the same branched clock). Referring to FIG. 7, the placement position of the flip-flop 22 at an end of the group A and the placement position of the flip-flop 23 at an end of the group B are spaced apart (with a distance). Then, in an example of FIG. 7, a signal path (data path) 31 is provided between the flip-flop 22 in the group A and the flip-flop 23 in the group B. Data transfer (data sending/reception) is performed between the flip-flops 22 and 23 through a combinatorial circuit or the like not shown on the signal path 31. That is, a data output signal output in synchronization with a clock signal for one flip-flop is sampled as a data input signal of the other flip-flop in synchronization with a clock signal through the combinatorial circuit or the like not shown. Respective skews of branched clocks for the flip-flops 22 and 23 need to be reduced.

In case that flip-flop groups are formed in consideration of placement positions thereof in the layout design of the semiconductor integrated circuit (LSI), flip-flops that belong to different groups are respectively driven by clocks of different groups, and that the flip-flops with data transfer performed therebetween are physically separated to each other, a branch position for clocks of the different groups that drive the flip-flops respectively is not located on a tree leaf side but on a side closer to a root buffer (clock source side). This is because when placement positions of the two flip-flops of different groups are separated with a distance in the clock tree layout, the branch needs to be arranged closer to a root side than in a case where the placement positions of the two flip-flops is near. For this reason, a value of a delay from the clock branch position to a leaf point of the clock tree will be increased, as a result of which, considering variations in a power supply and temperature, the clock skew will be increased.

As a clock tree reconfiguration method, Patent Document 1 discloses a design method for suppressing a variation in clock caused by fluctuations in temperature and voltage and restraining an increase in power consumption by reducing the number of CTS buffers inserted. In this method, connecting portions from the clock source that constitutes the clock supply source to the leaf point, which is the clock supply destination, are classified into the connecting portions each of which is connected by a gate and causes a gate delay and the connecting portions each of which is connected by a wire and causes a wiring delay, based on a physical distance. A clock tree is then formed, and a delay ratio between the gate delay and the wiring delay is obtained in each clock path (system). Then, redistribution is carried out so that this delay ratio and a delay time become constant in each clock path. In the method described in Patent Document 1, however, reduction in the clock skew caused by the fluctuations in temperature and voltage that may occur uniformly over an entire LSI chip is planned. For this reason, when a variation that may differ according to a location has occurred on the LSI chip, the variation that has occurred locally cannot not be effectively handled.

[Patent Document 1]

JP Patent Kokai Publication No. JP-P-2004-241699A

### SUMMARY OF THE DISCLOSURE

As described above, in case the clock tree is configured with flip-flops grouped according to the placement thereof, there is a problem that when data transfer is performed between flip-flops of the different groups, the amount of clock skew between the flip-flops is increased.

In the design method described in Patent Document 1, when the variations are different depending on respective locations in the LSI chip, the locally occurred variation cannot be effectively handled.

An apparatus in accordance with one aspect of the present invention is the apparatus for designing a semiconductor integrated circuit which including a clock tree in which a clock propagation path a from a clock supply source is branched to a plurality of paths in the form of a tree to reach clock supply destinations at leafs of the tree. The apparatus includes: means for receiving configuration information of the clock tree; and means for modifying the configuration of the clock tree so that a branch location of the clock tree is arranged closer to a leaf side of the clock tree.

Preferably, in the apparatus according to the present invention, the clock supply destinations arranged at the leafs of the tree are constituted from flip-flops; and the apparatus includes:

means for identifying from the configuration information of the clock tree a plurality of flip-flops driven by clocks on different branched paths, respectively with data transfer performed therebetween; and

means for modifying the configuration of the clock tree so that the branch location of the clocks for driving the plurality of flip-flops with the data transfer performed therebetween is arranged closer to the leaf of the clock tree.

In the apparatus according to the present invention, the clock supply destinations at the leafs of the tree are constituted from flip-flops; and the apparatus includes:

means for identifying from the configuration information of the clock tree two of the flip-flops, the two of the flip-flops belonging to first and second groups, respectively, with data transfer performed therebetween, the first and second groups being constituted from the flip-flops driven by first and second clocks on branched paths in the clock tree, respectively; and

means for comparing a delay in case the grouping of one of the two flip-flops belonging to one of the groups is changed to the other one of the groups with an original delay in case the change is not made, and changing the grouping of the one of the two flip-flops from the one of the groups to the other of the groups, if the comparison result indicates that a delay from the branch location to the one of the two flip-flops after the change is more reduced.

A method according to other aspect of the present invention is the method of designing a semiconductor integrated circuit including a clock tree in which a clock propagation path from a clock supply source is branched to a plurality of paths in the form of a tree and arriving at clock supply destinations at ends of the trees. The method includes the steps of:

inputting configuration information of the clock tree from storage means with the configuration information of the clock tree stored therein; and

modifying the configuration of the clock tree so that a branch location of the clock tree is arranged closer to a leaf of the clock tree.

In the method according to the present invention, the clock supply destinations at the leafs of the tree may be constituted from flip-flops. Then, a plurality of flip-flops driven by clocks on different branched paths, respectively, with data transfer performed therebetween may be identified from the configuration information of the clock tree. Then, the configuration of the clock tree may be modified so that the branch location of the clocks for driving the plurality of the flip-flops with the data transfer performed therebetween is arranged closer to the leaf of the clock tree. Alternatively, in the method according to the present invention, two of the flip-flops belonging to first and second groups, respectively, with data transfer performed therebetween may be identified from the configuration information of the clock tree. The first and second groups may be constituted from the flip-flops driven by first and second clocks on branched paths in the clock tree, respectively. Then, a delay in case grouping of one of the two flip-flops belonging to one of the groups is changed to the other one of the groups may be compared with an original delay in case the change is not made. As a result of comparison, if a delay from the branch location to the one of the two flip-flops after the change is more reduced, the grouping of the one of the two flip-flops may be changed from the one of the groups to the other of the groups.

A medium according to other aspect of the present invention stores therein the program for a computer constituting an apparatus for designing a semiconductor integrated circuit including a clock tree in which a clock propagation path from a clock supply source is branched to a plurality of paths in the form of a tree and arriving at clock supply destinations at ends of the trees. The program causes the computer to execute processing of:

inputting configuration information of the clock tree from storage means; and

modifying the configuration of the clock tree so that the branch location of the clock tree is arranged closer to the leaf of the clock tree.

In the medium according to the present invention, the clock supply destinations at the leafs of the tree may be constituted from flip-flops. The program may cause the computer to execute processing of:

identifying from the configuration information of the clock tree a plurality of flip-flops driven by clocks on different branched paths, respectively, with data transfer performed therebetween; and

modifying the configuration of the clock tree so that the branch location of the clocks for driving the plurality of the flip-flops with the data transfer performed therebetween is arranged closer to the leaf of the clock tree.

Preferably, in the medium according to the present invention, the program may cause the computer to execute processing of:

identifying from the configuration information of the clock tree two of the flip-flops, the two of the flip-flops belonging to first and second groups, respectively, with data transfer performed therebetween, the first and second groups being constituted from the flip-flops driven by first and second clocks on branched paths in the clock tree, respectively; and

comparing a delay in case grouping of one of the two flip-flops belonging to one of the groups is changed to the other one of the groups with an original delay in case the change is not made, and changing the grouping of the one of the two flip-flops from the one of the groups to the other of the groups, if the comparison result indicates that a delay from the branch location to the one of the two flip-flops after the change is more reduced.

The meritorious effects of the present invention are summarized as follows.

According to the present invention, the configuration of the clock tree is modified so that the clock branch location in the clock tree is arranged closer to a leaf point side, which is a clock supply destination, rather than a clock supply source side. A clock skew resulting from variations in clocks on branched paths can be thereby reduced.

According to the present invention, a common clock path from a clock source to the branch point is set to be relatively long. Variation factors on the common clock path will thereby exert a common influence on the branched clocks. A local variation within the LSI chip can be thereby effectively handled.

Still other features and advantages of the present invention will become readily apparent to those skilled in this art from the following detailed description in conjunction with the accompanying drawings wherein only the preferred embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram for explaining an principle underlying the present invention;

FIG. 2 is a diagram for explaining the principle underlying the present invention;

FIG. 3 is a diagram for explaining an embodiment of the present invention;

FIG. 4 is a diagram for explaining the embodiment of the present invention;

FIG. 5 is a flow diagram for explaining a processing procedure in the embodiment of the present invention;

FIG. 6 is a diagram showing a system configuration in the embodiment of the present invention; and

FIG. 7 is a diagram for explaining a conventional clock tree.

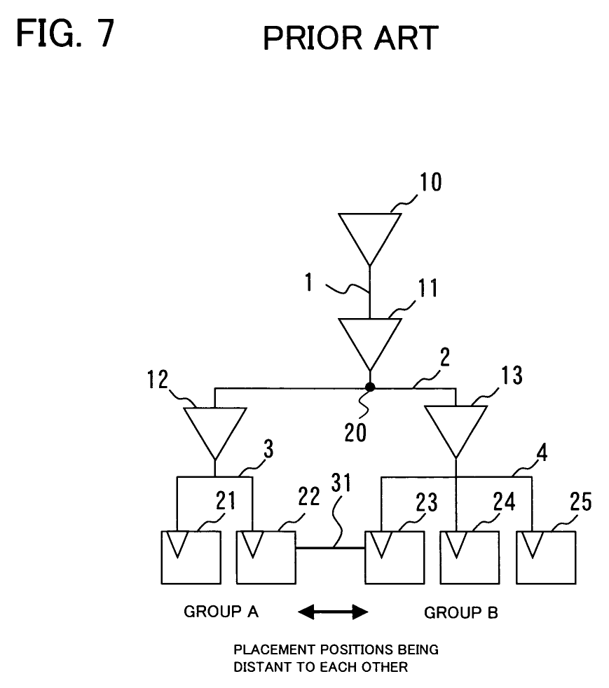

### PREFERRED EMBODIMENTS OF THE INVENTION

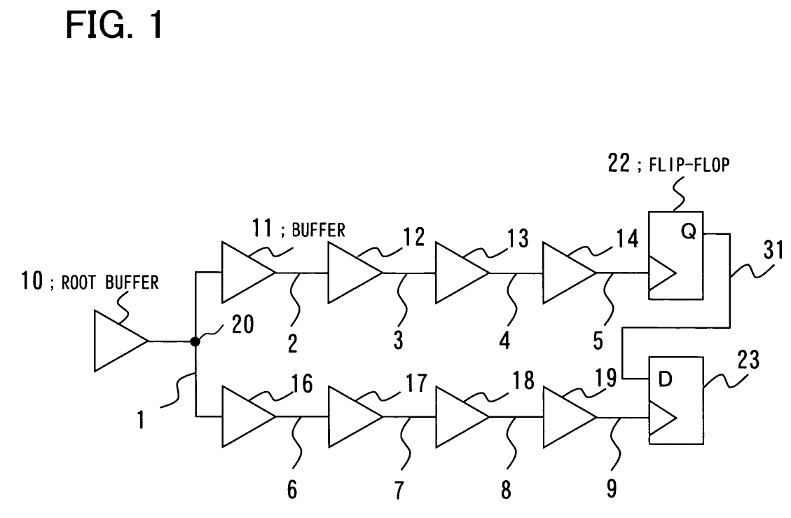

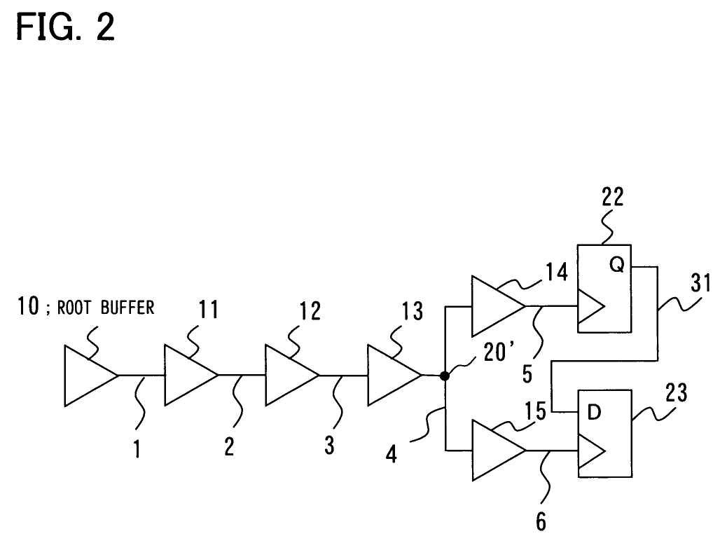

Preferred embodiments of the present invention will be described with reference to appended drawings. First, a principle underlying the present invention will be described. FIGS. 1 and 2 are diagrams for explaining the present invention. FIG. 1 schematically shows a layout of a clock tree synthesized according to a clock tree synthesis. FIG. 2 is a diagram schematically showing a layout of a clock tree changed from a configuration shown in FIG. 1. Referring to FIGS. 1 and 2, flip-flops 22 and 23 are the flip-flops between which data transfer is performed through a signal path 31, and are driven by branched clocks, respectively.

As shown in FIG. 1, when a branch position at which a clock path is branched to two paths is set to be located on a root side, a skew due to variations in a power supply and temperature will be increased between the clocks supplied to the flip-flops 22 and 23, respectively. The reason is as follows: The buffers (CTS buffers) in each clock path is constituted from four stages of the buffers, and larger the number of the stages of the buffers becomes and longer wiring for the buffers becomes, so that a variation in propagation delay will also become larger due to a variation in a propagation delay time in each of the buffers.

On contrast therewith, according to the present invention, as shown in FIG. 2, clocks obtained by branching at a position corresponding to one buffer before to the flip-flops 22 and 23 are supplied to the clock terminals of the flip-flops 22 and 23. In the case of the configuration of the layout in FIG. 2, the length of a common clock path from a clock source 10 to a branch point 20′ (through a net 1, a buffer 11, a net 2, a buffer 12, a net 3, and a buffer 13) (or a propagation delay time) is set to be longer than the length of a path from the branch point 20′ to the clock terminal of the flip-flop 22 through a buffer 14 or to the clock terminal of the flip-flop 23 through a buffer 15 (or a propagation delay time). In this case, a variation factor on the common clock path will exert a common influence on the branched clocks. Thus, a variation on the common clock path may be compensated at the clock terminals of the flip-flops 22 and 23, so that only variations on the paths from the branch point 20′ to the flip-flops 22 and 23 become a factor for the clock skew.

As described above, according to the present invention, it is configured so that a local variation within an LSI chip (local variation that influence the common clock path) is given to branched destinations as a common variation. The local variation within the LSI chip can be thereby effectively handled. On the other hand, in the configuration of the layout in FIG. 1, the variation on the each path from a branch point 20 to the clock terminals of the flip-flops 22 and 23 as it is becomes a factor for clock skew.

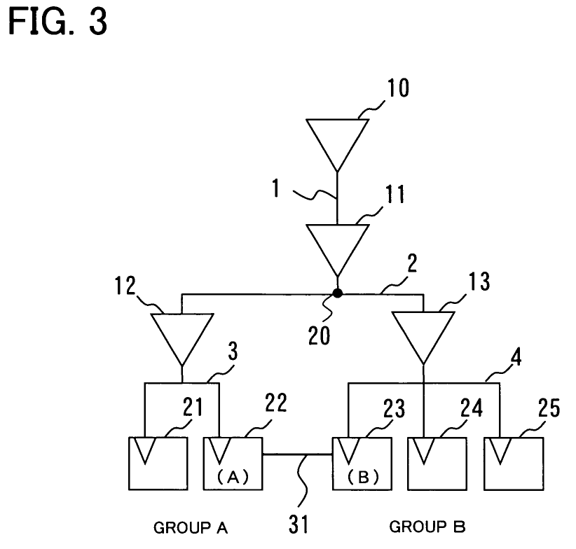

FIG. 3 is a diagram of an embodiment of the present invention. Data transfer (data sending/reception) is executed between the flip-flop (A) 22 of the group A and the flip-flop (B) 23 of the group B and a clock is branched at a branch point.

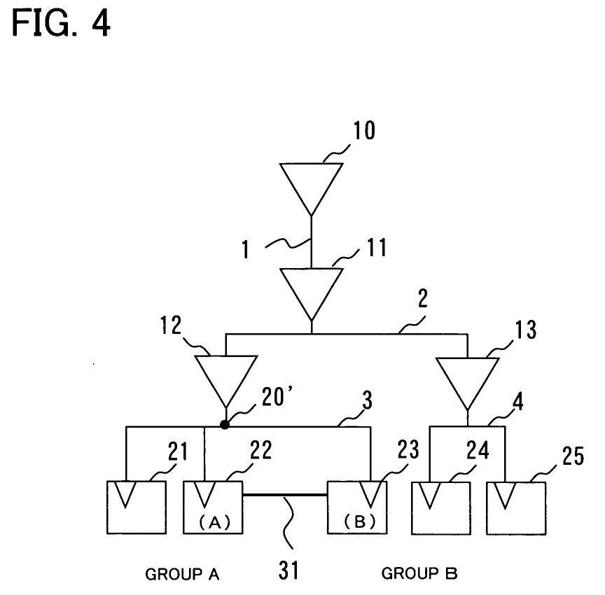

FIG. 4 is a diagram showing a result obtained by changing a clock tree layout configuration in FIG. 3 according to the present invention. The flip-flop (A) 22 and the flip-flop (B) 23 between which data transfer is performed belong to the same group A in terms of a clock system. A clock branch point 20′ is closer to a leaf point by one stage (of a buffer output) than the configuration in FIG. 3.

In the configuration in FIG. 3, the flip-flops 22 and 23 belong to the two groups A and B, respectively. When the flip-flops 22 and 23 are classified into different groups, for example by automatic placement though the flip-flops 22 and 23 are spaced apart only by a slight distance, the group to which the flip-flop 23 belongs is changed from the group B to the group A, and the clock for the flip-flop 23 is switched to the clock output from the buffer 12. Meanwhile, the adjustment of buffer driving capability due to this layout modification may be performed appropriately. In FIG. 3, the buffer 12 drives the two flip-flops 21 and 22. In FIG. 4, the buffer 12 drives the three flip-flops 21, 22, and 23. Thus, with this modification, the buffer 12 may be changed to the buffer suited to driving the three flip-flops. In FIG. 3, the buffer 13 drives three flip-flops. With modification of the configuration shown in FIG. 4, the buffer 13 may be changed to the buffer suited to driving two flip-flops. Further, the branch position 20′ for supplying the clock to the three flip-flops 21, 22, and 23 of the group A in FIG. 4 may be of course positioned at a symmetrical midpoint on the net 3.

When a change due to a variation in a clock delay is expressed by multiplication of a path delay on a clock path by a coefficient of the variation in the present embodiment, a difference between a delay to the flip-flop (A) 22 from the root buffer 10 and a delay to the flip-flop (B) 23 from the root buffer 10 in a clock tree or a skew Skew (A)_(B) between the flip-flops 22 and 23 is given by the following expression (1):
Skew (A)_(B)=Delay_branchTO(A)−Delay_branchTO(B)*α (1)

in which Delay_branchTO(A) is a value of a delay from the branch point to the flip-flop (A)22, and Delay_branchTO(B) is a value of a delay from the branch point to the flip-flop (B)23.

In order to reduce the Skew (A)_(B), the configuration is made so that the clock branch position is located close to the leaf point, as shown in FIGS. 2 and 4, in place of the configurations in FIGS. 1 and 3, respectively.

A location where the clock skew needs to be reduced (such as a critical section) is flip-flops between which data transfer is performed. For this reason, in the present embodiment, the flip-flops which belong to different groups and between which the data transfer is performed are identified using layout information on the clock tree (e.g. the clock tree as in FIG. 3, created by a conventional method), and a group change is performed so that branching for the clocks to be supplied to these flip-flops is performed at a location on a side of an end of the clock tree.

At that occasion, the group change is performed when Delay_branchTO(A) or Delay_branchTO(B) in the above expression (1) after a modification of a clock tree configuration is a value smaller than that in a case where the clock tree configuration is not modified.

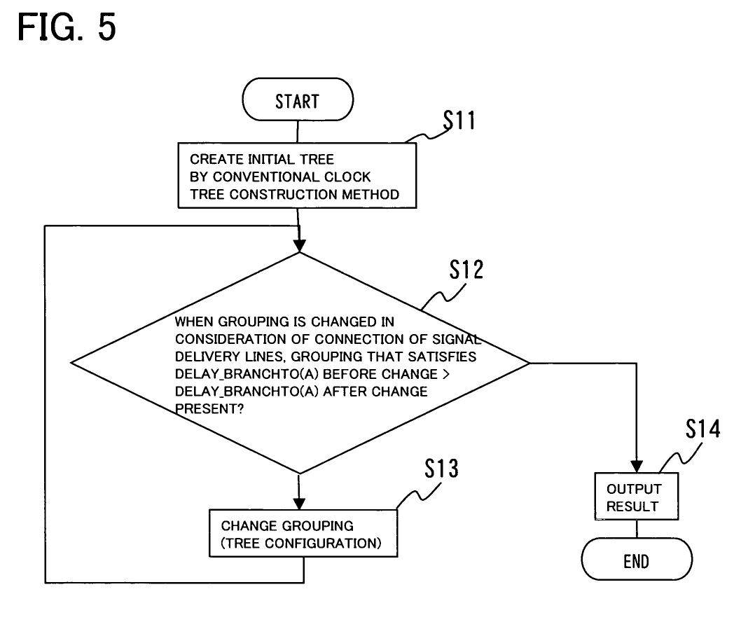

FIG. 5 is a diagram for explaining a processing procedure according to the embodiment of the present invention. Referring to FIG. 5, the processing procedure in the present embodiment will be explained.

A clock tree (also referred to as an “initial tree”) is created according to the existing clock tree synthesis method (that uses an existent clock tree synthesis tool of a layout apparatus) (at step S11).

When grouping is changed in consideration of connection of signal delivery lines, and when about a delay time Delay_branchTO(A) from the branch point to a flip-flop with the belonging group thereof changed, grouping that satisfies Delay_branchTO(A) before the change>Delay_branchTO(A) after the change is present, the change of the group for the flip-flop is performed (at step S12).

When grouping that satisfies Delay_branchTO(A) before the change>Delay_branchTO(A) after the change is not present for a flip-flop on a net, the result is output, and the procedure is completed (at step S13).

Generally, in a clock tree synthesis, the tree is configured so that
Delay_branchTO(A)≈Delay_branchTO(B) (2)

In this case, the above expression (1) is approximated by the following expression (3):

$$\begin{matrix}Skew ( A ) \_ ( B ) \approx Delay\_branchTO ( A ) * ( 1 - α ) \\ \approx Delay\_branchTO ( B ) * ( 1 - α )\end{matrix} \qquad ( 3 )$$

In order to reduce the clock skew (A)_(B) in the above expression (3), Delay_branchTO(A) (or Delay_branchTO(B)) should be reduced using (1−α) as a constant. Then, in order to implement this, the branch position should be closer to the leaf point of the tree, as shown in FIG. 2, than in FIG. 1. This is the constitutional principle of the present invention.

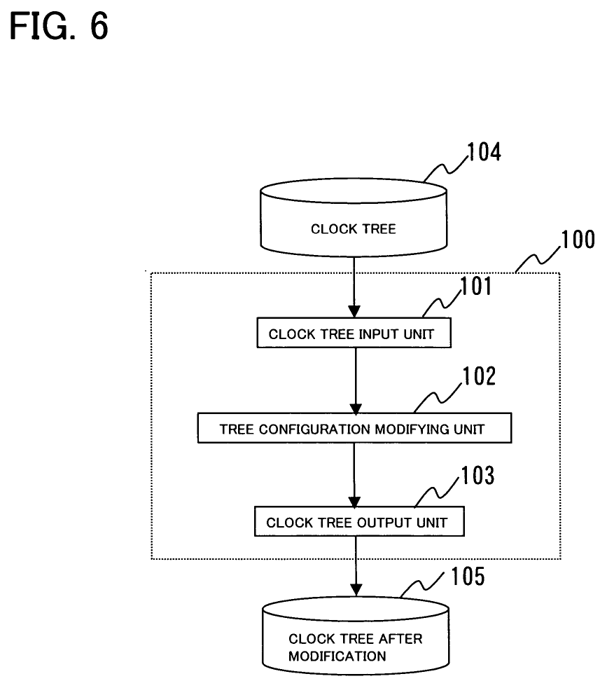

FIG. 6 is a diagram showing a system configuration of a design system in the embodiment of the present invention. A device 100 in the present embodiment is the device that optimizes the tree configuration of a clock tree automatically synthesized by a clock synthesis tool, and is installed on a computer (or a data processing device). Alternatively, the device 100 may be incorporated into an automatic layout device for performing automatic placement and routing. Referring to FIG. 6, the device 100 in the present embodiment includes a clock tree input unit 101 for receiving information on the clock tree (layout information) synthesized by the clock tree synthesis tool, a tree configuration modifying unit 102, and a clock tree output unit 103 for outputting the modified (optimized) clock tree. Meanwhile, the same storage unit may be of course used for a storage unit 105 for storing the modified (optimized) clock tree and a storage unit 104 for storing information on an original clock tree. The tree configuration modifying unit 102 searches for flip-flops between which data transfer is performed and which are driven by mutually different clock paths using netlist information on the input clock tree. When the flip-flops are present, a trial is made to see whether clock branching position can be changed to a side closer to the leaf point so that the flip-flop of one group is driven by a clock from a system for the other group. When the change can be made and a delay from the branch position to the flip-flop after the change is more reduced than a delay from the branch position to the flip-flop before the change, modification of the tree configuration is performed. That is, processing using the procedure shown in FIG. 5 is executed. Functions of processing by the clock tree input unit 101, the tree configuration modifying unit 102, and the clock tree output unit 103 may be performed by a program to be executed by the computer.

While the above description of the present invention was made in connection with the embodiment described above, the present invention is not of course limited to configurations of the embodiment described above. The present invention of course includes various modifications and variations that could be made by those skilled in the art within the scope of the present invention.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. An apparatus for designing a semiconductor integrated circuit including a clock tree, in which a clock propagation path from a clock supply source is branched to a plurality of paths in the from of a tree to reach respective clock supply destinations at leafs of said tree, said apparatus comprising:
a unit receiving configuration information of said clock tree; and
a unit modifying the configuration of said clock tree so that a branch location in said clock tree is arranged closer to a leaf side of said clock tree.

2. The apparatus according to claim 1, wherein said clock supply destinations at said leafs of said tree comprise flip-flops; and
wherein said apparatus comprises:
a unit for identifying from the configuration information of said clock tree a plurality of flip-flops driven by clocks on different branched paths, respectively, with data transfer performed therebetween; and
a unit for modifying the configuration of said clock tree so that the branch location of clocks for driving said plurality of flip-flops with the data transfer performed therebetween is arranged closer to said leaf side of said tree.

3. The apparatus according to claim 1, wherein said clock supply destinations at said leafs of said tree comprise flip-flops; and
wherein said apparatus comprises:
a unit for identifying from the configuration information of said clock tree two of said flip-flops, said two of said flip-flops belonging to first and second groups, respectively, with data transfer performed therebetween, said first and second groups comprising flip-flops driven respectively by first and second clocks on branched paths in said clock tree, respectively; and
a unit for comparing a delay in case grouping of one of said two flip-flops belonging to one of said groups is changed to the other one of said groups with an original delay in case the change is not made, and changing the grouping of said one of said two flip-flops from said one of said groups to the other of said groups, if the comparison result indicates that a delay from the branch location to said one of said two flip-flops after the change is more reduced.

4. The apparatus according to claim 3, wherein said groups for said flip-flops are grouped based on placement positions of said flip-flops.

5. A method of designing a semiconductor integrated circuit including a clock tree, in which a clock propagation path from a clock supply source is branched to a plurality of paths in the from of a tree to reach respective clock supply destinations at leafs of said tree, said method comprising the steps of:
inputting configuration information of said clock tree from storage means with the configuration information of said clock tree stored therein; and
modifying the configuration of said clock tree so that a branch location of said clock tree is arranged closer to a leaf side of said tree.

6. The method according to claim 5, wherein said clock supply destinations at said leafs of said tree comprise flip-flops; and
wherein said method comprises the steps of:
identifying from the configuration information of said clock tree a plurality of flip-flops driven by clocks on different branched paths, respectively, with data transfer performed therebetween; and
modifying the configuration of said clock tree so that the branch location of the clocks for driving said plurality of flip-flops with the data transfer performed therebetween is arranged closer to said leaf side of said tree.

7. The method according to claim 5, wherein said clock supply destinations at said leafs of said tree comprise flip-flops; and
wherein said method comprises the steps of:
identifying from the configuration information of said clock tree two of said flip-flops, said two of said flip-flops belonging to first and second groups, respectively, with data transfer performed therebetween, said first and second groups comprising the flip-flops driven respectively by first and second clocks on branched paths in said clock tree, respectively; and
comparing a delay in case grouping of one of said two flip-flops belonging to one of said groups is changed to the other one of said groups with an original delay in case the change is not made, and changing the grouping of said one of said two flip-flops from said one of said groups to the other of said groups, if the comparison result indicates that a delay from the branch location to said one of said two flip-flops after the change is more reduced.

8. The method according to claim 7, wherein said groups for said flip-flops are grouped based on placement positions of said flip-flops.

9. A medium for recording a computer program for a computer constituting an apparatus for designing a semiconductor integrated circuit including a clock tree, in which a clock propagation path from a clock supply source is branched to a plurality of paths in the from of a tree to reach respective clock supply destinations at leafs of said tree, said program causing said computer to execute processing of:
inputting configuration information of said clock tree from storage means with the configuration information of said clock tree stored therein; and
modifying the configuration of said clock tree so that a branch location of said clock tree is arranged closer to a leaf of said clock tree.

10. The medium according to claim 9, wherein said clock supply destinations at said leafs of said tree comprise flip-flops; and wherein
said program causes said computer to execute processing of:
identifying from the configuration information of said clock tree a plurality of flip-flops driven by clocks on different branched paths, respectively, with data transfer performed therebetween; and
modifying the configuration of said clock tree so that the branch location of the clocks for driving said plurality of flip-flops with the data transfer performed therebetween is arranged closer to said leaf of said tree.

11. The medium according to claim 9, wherein said clock supply destinations at said leafs of said tree comprise flip-flops; and wherein
said program causes said computer to execute processing of:
identifying from the configuration information of said clock tree two of said flip-flops, said two of said flip-flops belonging to first and second groups, respectively, with data transfer performed therebetween, said first and second groups comprising the flip-flops driven respectively by first and second clocks on branched paths in said clock tree, respectively; and
comparing a delay in case grouping of one of said two flip-flops belonging to one of said groups is changed to the other one of said groups with an original delay in case the change is not made, and changing the grouping of said one of said two flip-flops from said one of said groups to the other of said groups, if the comparison result indicates that a delay from the branch location to said one of said two flip-flops after the change is more reduced.

12. The medium according to claim 11, wherein said groups for said flip-flops are grouped based on placement positions of said flip-flops.
